(19) United States
(12) Patent Application Publication
(10) Pub. No.: US 2023/0325873 A1
(43) Pub. Date: Oct. 12, 2023

(54) METHOD AND SYSTEM FOR TRAINING A MACHINE LEARNING ALGORITHM TO PREDICT A VISIBILITY SCORE

(71) Applicant: YANDEX EUROPE AG, Luzen (CN)

(72) Inventors: Maksim Ilich STEBELEV, Khimki (RU); Artem Viktorovich VOROZHTSOV, Kirovo-Chepetsk (RU); Pavel Vladimirovich KALININ, Gubkin (RU)

(21) Appl. No.: 18/133,963

(22) Filed: Apr. 12, 2023

(30) Foreign Application Priority Data
Apr. 12, 2022 (RU) 2022109783

(51) Int. Cl. G06Q 30/0251; G06N 20/00; G06Q 30/0273

(52) U.S. Cl. CPC G06Q 30/0254; G06N 20/00; G06Q 30/0275

(57) ABSTRACT

There is disclosed a system and a method for training an MLA to predict a visibility score indicative of a likelihood of a targeted message included within a web resource, the method being executable on a server, the method comprising: generating a training dataset by retrieving a plurality of training targeted messages, the training web resource having a plurality of targeted message slots for placing therein one or more training targeted messages; causing, the training electronic device to display the training web resource; upon the training user accessing the training web resource using the training electronic device during a subsequent instance of time, causing the training electronic device to display the web resource; tracking an activity parameter, the activity parameter being indicative of an interaction by the training user with the given one of the plurality of training targeted messages; generating the training dataset.

### CROSS-REFERENCE

The present application claims priority to Russian Patent Application No. 2022109783, entitled “Method and System for Training a Machine Learning Algorithm to Predict a Visibility Score”, filed Apr. 12, 2022, the entirety of which is incorporated herein by reference.

### FIELD

The present technology relates to a method and system for training a machine learning algorithm (MLA) in general, and specifically to a method and system for training a MLA to predict a visibility score indicative of a likelihood of a targeted message included within a web resource being viewed by a user.

### BACKGROUND

Various global or local communication networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment-related information. Users use a variety of client devices (desktop, laptop, notebook, smartphone, tablets and the like) to have access to rich content (like images, audio, video, animation, and other multimedia content from such networks).

While navigating on the Internet, a given user is exposed to a plurality of online marketing targeted messages. Online marketing is the practice of using web-based channels to spread a message about products, or services to its potential customers.

Generally speaking, there exist two methods for providing a targeted message. The first method is click-based (i.e. cost per click), where the cost to market the targeted message is incurred when the user clicks on the targeted message. The second method is impression-based (i.e. cost per view), where the cost to market the targeted message is incurred when the targeted message is viewed by the user.

Needless to say, the latter is more difficult to quantify, as it is difficult to determine, with certainty, that a given user has indeed seen the targeted message.

PCT Publication No. 2014/200716 A1 entitled “View-Based Pricing of Advertisements in Scrollable Advertisements Units” published on Dec. 18, 2014 and assigned to Facebook, Inc., discloses an online system that determines the pricing of an advertisement included in a scrollable advertisement unit including multiple advertisements and a display area presenting one or more advertisements. When an advertisement is included in a scrollable advertisement unit, a price for presentation of the advertisement is determined based on bid amounts of advertisements evaluated for inclusion in the scrollable advertisement unit and a scaling factor. The scaling factor is based on the probability of the advertisement being presented to a user based on the position in the scrollable advertisement unit associated with the advertisement. Advertisement characteristics affecting the likelihood of an advertisement being presented to a user may also be considered in the scaling factor.

United States Patent Publication No. 2014/236710 A1 entitled “On-Line Advertising Valuation” published on Aug. 21, 2014 and assigned to Congoo LLC, discloses a method of valuing online advertising locations. A clickable ad is served to, an online advertising location and a click total an impression total are obtained for a pre-determined time period. These are used to calculate the click-through-ration (CTR). Optionally, knowing the cost per click of the ad, an effective cost per thousand (eCPM) is also calculated.Either the CTR or the eCPM, or both, are used as the location score. Location scores are obtained for locations over an advertising domain. Individual location scores are then ranked relative to the average location score for the domain. These ranked scores are used by automated bidding servers to optimize buying on-line advertising locations on a content domain.

United States Patent Publication No. 2011/231241 A1 entitled “Real-Time Personalization of Sponsored Search Based on Predicted Click Propensity” published on Sep. 22, 2011 and assigned to Verizon Media Inc., discloses employing long and short term historical user click propensity behaviors to adapt or filter a number of advertisements displayed and their location on a search results' page. A network device tracks a user's short and long term historical click behaviors. For a given search query for the user, a variety of candidate advertisements are selected. A normalized click-through rate (COEC) is estimated for each advertisement. The COEC and the user's short and long term click behavior, represented by User Click Propensity (UCP), is used to generate a User effective Cost Per Thousand (UeCPM) value. Candidate advertisements are filtered based on a minimum threshold value for UeCPMs. Page placement for the remaining advertisements is determined based on a user expected revenue for an advertisement determined from the UCP. Advertisements having a user expected revenue above another threshold are placed in a north page location.

### SUMMARY

It is an object of the present technology to provide improved method and systems for determining a likelihood of a targeted message included within a web resource being viewed by a user.

Currently, there is a plurality of parameters being used to select a targeted message to be displayed on a web resource. Such conventional parameters may include, for example, a targeted message content, a relevance of the targeted message to the user's interests, a size of the targeted message, and the like. Needless to say, it remains difficult to quantify, or estimate, the actual number of users that have seen, or noticed, a given targeted message.

The developers of the present technology hypothesize that a likelihood of a user noticing a targeted message on a web resource depends on the placement of the targeted message on the web resource. In other words, the developers of the present technology have developed embodiments thereof based on a premise that by using previous user click locations as proxies, a machine learning algorithm (MLA) can be trained to determine the likelihood of the user noticing a targeted message.

Typically, MLAs are used to estimating probabilities in a computer-implemented setting. Generally speaking, an MLA builds a mathematical model in order to determine probabilities, without being explicitly programmed to perform the task.

Prior to using the MLA in real-time, the MLA needs to be trained using sample data, known as “training data”. Generally speaking, the training data is a plurality of pairs, where each pair consists of a training sample object and an indication of a target associated with the training sample object (a binary parameter).

An issue in determining the probability of a given targeted message being viewed by a user is the lack of training data. This is due to the fact that there is no precise data confirming whether a given user has noticed/viewed the targeted message within a web resource, and thus it is technically challenging to create a precise training data.

Without wishing to be bound by any specific theory, embodiments of the present technology have been developed based on an assumption that in order to create the training data representing whether a given user has seen the targeted message, it is possible to use click activity of training targeted message, as a proxy, to determine a link between a location on a web page and a likelihood of a user seeing a targeted message placed therein.

The developers of the present technology have assumed that the probability of seeing a targeted message in a given location of the targeted message is proportionate to a probability of the targeted message being clicked at the given location.

In accordance with a first broad aspect of the present technology, there is disclosed a computer-implemented method for training a machine learning algorithm (MLA) to predict a visibility score indicative of a likelihood of a targeted message included within a web resource being viewed by a user, the user being associated with an electronic device configured to display the web resource, the method being executable on a server accessible by the electronic device via a communication network, the method comprising, at a training-phase: generating a training dataset by: retrieving, by the server, from a database of training targeted messages, a plurality of training targeted messages, one or more training targeted messages of the plurality of training targeted messages to be placed within a training web resource, the training web resource having a plurality of targeted message slots for placing therein one or more training targeted messages; upon a training user accessing the training web resource using a training electronic device during a first instance of time, causing, by the server, the training electronic device to display the training web resource, a given one of the plurality of training targeted messages being placed at a first targeted message slot; upon the training user accessing the training web resource using the training electronic device during a subsequent instance of time, causing, by the server, the training electronic device to display the web resource, the given one of the plurality of training targeted messages being placed at an other targeted message slot; tracking, by the server, an activity parameter for each of the first targeted message slot and the other targeted message slot, the activity parameter being indicative of an interaction by the training user with the given one of the plurality of training targeted messages placed at the respective one of first targeted message slot and the other targeted message slot; generating, by the server, the training dataset, the training dataset comprising (i) the training web resource; (ii) an indication of an associated one of the first targeted message slot and the other targeted message slot as a location of the given training targeted message within the training web resource; and (iii) the activity parameter associated with the location; training the MLA, the training including: determining, by the server, a set of features associated with the training dataset, the set of features including at least: a position-activity feature, the position-activity feature being indicative of a relation between the location of the given training targeted message and the activity parameter; generating an inferred function based on the set of features, the inferred function being configured to determine the visibility score of the targeted message included within the web resource based on a targeted message location of the targeted message.

In some non-limiting embodiments of the method, the visibility score is determined without the user clicking on the targeted message.

In some non-limiting embodiments of the method, the activity parameter is indicative of at least one of a click activity or a hover activity by the training user with the given one of the plurality of training targeted messages.

In some non-limiting embodiments of the method, the click activity parameter is a binary parameter.

In some non-limiting embodiments of the method, the training uses the activity parameter as a proxy for the likelihood of the targeted message being viewed.

In some non-limiting embodiments of the method, the use of the activity parameter as a proxy for the likelihood of the targeted message being viewed is based on a formula p(click)=p(click|view)*p(view)+p(click|!view)*p(!view).

In some non-limiting embodiments of the method, the training web resource is associated with a content topic; and wherein the set of features further comprises: a content-activity feature, the content activity feature being indicative of a relation between the location of the given training targeted message, the content topic and the activity parameter.

In some non-limiting embodiments of the method, the inferred function is configured to determine the visibility score of the targeted message included within the web resource based on the targeted message location and the content topic of the web resource.

In some non-limiting embodiments of the method, the training electronic device is associated with a device type; and wherein the set of features further comprises: a device-activity feature, the device-activity feature being indicative of a relation between the location of the given training targeted message, the activity parameter and the device type.

In some non-limiting embodiments of the method, the inferred function is configured to determine the visibility score of the targeted message included within the web resource based on the targeted message location and the device type of the electronic device.

In some non-limiting embodiments of the method, the training user is associated with a user profile, the user profile being indicative of web navigation characteristics associated with the training user.

In some non-limiting embodiments of the method, the training dataset further comprises the training user profile and the content topic, and wherein the set of features further comprises: a preference-activity feature, the preference-activity feature being indicative of a relation between the training user profile, the location of the training targeted message, and the activity parameter.

In some non-limiting embodiments of the method, the inferred function is configured to determine the visibility score based on the user profile associated with the user and the targeted message location of the targeted message.

In some non-limiting embodiments of the method, during an in-use phase: receiving, by the server, from the electronic device, a request for the web resource, the web resource having a plurality of potential locations for including the targeted message; executing, by the server, an impression bid process prior to including the targeted message at the targeted message location of the web resource.

In some non-limiting embodiments of the method, executing the impression bid process comprises: retrieving, by the server, from a targeted message database, the targeted message associated with a target visibility score; generating, by the server, the visibility score for the targeted message for each potential location of the plurality of potential locations; selecting, by the server, a given potential location associated with the visibility score that matches the target visibility score.

In some non-limiting embodiments of the method, the impression bid process is based on a pay-per-view model.

In some non-limiting embodiments of the method, the targeted message is a media ad.

In accordance with another broad aspect of the present technology, there is disclosed a system for training a machine learning algorithm (MLA) to predict a visibility score indicative of a likelihood of a targeted message included within a web resource being viewed by a user, the user being associated with an electronic device configured to display the web resource, the system comprising a server accessible by the electronic device via a communication network, the server comprising a processor, the processor being configured to, at a training-phase: generate a training dataset by: retrieve, from a database of training targeted messages, a plurality of training targeted messages, one or more training targeted messages of the plurality of training targeted messages to be placed within a training web resource, the training web resource having a plurality of targeted message slots for placing therein one or more training targeted messages; upon a training user accessing the training web resource using a training electronic device during a first instance of time, cause, by the server, the training electronic device to display the training web resource, a given one of the plurality of training targeted messages being placed at a first targeted message slot; upon the training user accessing the training web resource using the training electronic device during a subsequent instance of time, cause the training electronic device to display the web resource, the given one of the plurality of training targeted messages being placed at an other targeted message slot; track, an activity parameter for each of the first targeted message slot and the other targeted message slot, the activity parameter being indicative of an interaction by the training user with the given one of the plurality of training targeted messages placed at the respective one of first targeted message slot and the other targeted message slot; generate, the training dataset, the training dataset comprising (i) the training web resource; (ii) an indication of an associated one of the first targeted message slot and the other targeted message slot as a location of the given training targeted message within the training web resource; and (iii) the activity parameter associated with the location; train the MLA, the processor being configured to train the MLA by: determine a set of features associated with the training dataset, the set of features including at least: a position-activity feature, the position-activity feature being indicative of a relation between the location of the given training targeted message and the activity parameter; generate an inferred function based on the set of features, the inferred function being configured to determine the visibility score of the targeted message included within the web resource based on a targeted message location of the targeted message.

In some non-limiting embodiments of the system, the activity parameter is indicative of at least one of a click activity or a hover activity by the training user with the given one of the plurality of training targeted messages.

In some non-limiting embodiments of the system, the training phase uses the activity parameter as a proxy for the likelihood of the targeted message being viewed.

In the context of the present specification, the expression “information” includes information of any nature or kind whatsoever capable of being stored in a database. Thus information includes, but is not limited to audiovisual works (images, movies, sound records, presentations, etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram depicting a system, the system being implemented in accordance with non-limiting embodiments of the present technology.

FIG. 2 is a non-limiting embodiment of an illustration of a targeted message database of the system of FIG. 1.

FIG. 3 is a schematic illustration of a web resource that is accessed by a browser application executed in the system of FIG. 1.

FIG. 4 depicts a schematic process of a training phase of an MLA executed in the system of FIG. 1.

FIG. 5 is a schematic diagram of a process of the in-use phase of an advertisement application executed in the system of FIG. 1.

FIG. 6 depicts a block diagram of a flow chart of a method for predicting a visibility score executed in the system of FIG. 1.

### DETAILED DESCRIPTION

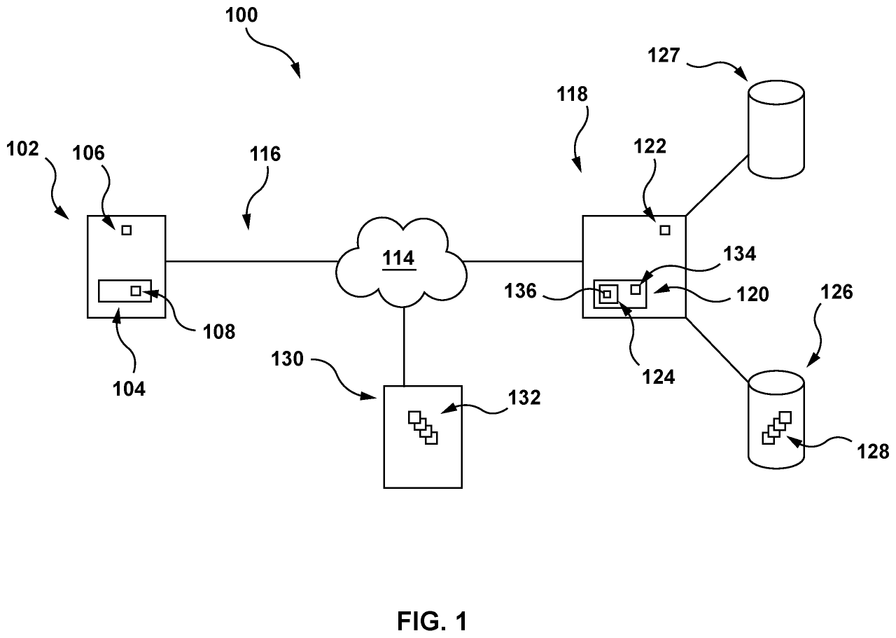

Referring to FIG. 1, there is shown a schematic diagram of a system 100, the system 100 being suitable for implementing non-limiting embodiments of the present technology. It is to be expressly understood that the system 100 is depicted merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope. Furthermore, as an aid to understanding, the following description may describe relatively simplified implementations of the present technology. As persons skilled in the art would understand, various implementations of the present technology may be of greater complexity.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labelled as a “processor” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some non-limiting embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

With these fundamentals in place, we will now consider some non-limiting examples to illustrate various implementations of aspects of the present technology.

The system 100 comprises an electronic device 102. The electronic device 102 is typically associated with a user (not depicted) and, as such, can sometimes be referred to as a “client device”. It should be noted that the fact that the electronic device 102 is associated with the user does not mean to suggest or imply any mode of operation—such as a need to log in, a need to be registered or the like.

In the context of the present specification, unless provided expressly otherwise, “electronic device” is any computer hardware that is capable of running a software appropriate to the relevant task at hand. Thus, some (non-limiting) examples of electronic devices include personal computers (desktops, laptops, netbooks, etc.), smartphones, and tablets. It should be noted that a device acting as an electronic device in the present context is not precluded from acting as a server to other electronic devices. The use of the expression “an electronic device” does not preclude multiple client devices being used in receiving/sending, carrying out or causing to be carried out any task or request, or the consequences of any task or request, or steps of any method described herein.

The electronic device 102 includes a permanent storage 104. The permanent storage 104 may encompass one or more storage media and generally provides a place to store computer-executable instructions executable by a processor 106. By way of an example, the permanent storage 104 may be implemented as a computer-readable storage medium including Read-Only Memory (ROM), hard disk drives (HDDs), solid-state drives (SSDs), and flash-memory cards.

The electronic device 102 includes hardware and/or software and/or firmware (or a combination thereof) to execute a browser application 108. Generally speaking, the purpose of the browser application 108 is to enable the user to navigate the Internet. The manner in which the browser application108 is implemented is known in the art and will not be described herein. Suffice to say that the browser application 108 may correspond to a Yandex™ browser application. It should be expressly understood that any other commercially available or proprietary browser application can be used for implementing non-limiting embodiments of the present technology.

Generally speaking, the electronic device 102 comprises a user input interface (not shown) (such as a keyboard) for receiving user inputs into, for example, a query interface (not shown). How the user input interface is implemented is not particularly limited and will depend on how the electronic device 102 is implemented. Merely as an example and not as a limitation, in those embodiments of the present technology where the electronic device 102 is implemented as a wireless communication device (such as an iPhone™ smart phone), the user input interface can be implemented as a soft keyboard (also called an on-screen keyboard or software keyboard). On the other hand, where the electronic device 102 is implemented as a personal computer, the user input interface can be implemented as a hard keyboard.

The electronic device 102 comprises a communication interface (not depicted) for enabling two-way communication with a communication network 114 via a communication link 116. In some non-limiting embodiments of the present technology, the communication network 114 can be implemented as the Internet. In other embodiments of the present technology, the communication network 114 can be implemented differently, such as any wide-area communication network, local area communications network, a private communications network and the like.

How the communication link 116 is implemented is not particularly limited and depends on how the electronic device 102 is implemented. Merely as an example and not as a limitation, in those embodiments of the present technology where the electronic device 102 is implemented as a wireless communication device (such as a smart phone), the communication link 116 can be implemented as a wireless communication link (such as, but not limited to, a 3G communications network link, a 4G communications network link, a Wireless Fidelity, or Wi-Fi®, for short, Bluetooth®, or the like) or wired (such as an Ethernet based connection).

It should be expressly understood that implementations for the electronic device 102, the communication link 116 and the communication network 114 are provided for illustration purposes only. As such, those skilled in the art will easily appreciate other specific implementational details for the electronic device 102, the communication link 116, and the communication network 114. As such, by no means the examples provided hereinabove are meant to limit the scope of the present technology.

The system 100 further includes a server 118 coupled to the communication network 114. The server 118 can be implemented as a computer server. In an example of an embodiment of the present technology, the server 118 can be implemented as a Dell™ PowerEdge™ Server running the Microsoft™ Windows Server™ operating system. Needless to say, the server 118 can be implemented in any other suitable hardware and/or software and/or firmware or a combination thereof. In the depicted non-limiting embodiment of the present technology, the server 118 is a single server. In alternative non-limiting embodiments of the present technology, the functionality of the server 118 may be distributed and may be implemented via multiple servers.

The server 118 includes a communication interface (not depicted) structured and configured to communicate with various entities (such as the electronic device 102 and other devices potentially coupled to the communication network 114) via the communication network 114. The server 118 includes a server memory 120 which includes one or more storage media and generally provides a place to store computer-executable program instructions executable by a server processor 122. By way of example, the server memory 120 may be implemented as a tangible computer-readable storage medium including Read-Only Memory (ROM) and/or Random-Access Memory (RAM). The server memory 120 may also include one or more fixed storage devices in the form of, by way of example, hard disk drives (HDDs), solid-state drives (SSDs), and flash-memory cards.

In some non-limiting embodiments, the server 118 can be operated by the same entity that has provided the afore-described browser application 108. For example, if the browser application 108 is a Yandex.Navigator™ application, the server 118 can be operated by Yandex LLC of Lev Tolstoy Street, No. 16, Moscow, 119021, Russia. In alternative embodiments, the server 118 can be operated by an entity different from the one that has provided the aforementioned browser application 108.

In some non-limiting embodiments of the present technology, the server 118 provides a search engine application 134 (such as Yandex Search™) which is accessible by the browser application 108 via the communication network 114. The manner in which the search engine application 134 is implemented is known in the art and therefore will not be described in detail herein.

In accordance with the non-limiting embodiments of the present technology, the server 118 is also configured to execute an advertisement application 124. The manner in which the advertisement application 124 is implemented is described in detail below.

The server 118 is communicatively coupled to a targeted message database 126. In alternative non-limiting embodiments, the targeted message database 126 may be communicatively coupled to the server 118 via the network 114. Although the targeted message database 126 is illustrated schematically herein as a single entity, it is contemplated that the targeted message database 126 may be configured in a distributed manner.

The targeted message database 126 is populated with a plurality of targeted messages 128. Broadly speaking, a targeted message may be embodied in a digital advertisement, comprising one or more banner ads, image ads, media ads, etc.

Although in the present description, the search engine application 134 and the advertisement application 124 are illustrated as to separate application, it is done so for ease of understanding. It is contemplated that functionality of the advertisement application 124 described below be executed by the search engine application 134.

### Targeted Message Database 126

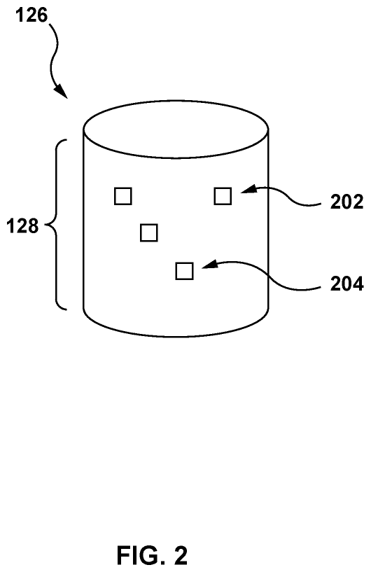

With reference to FIG. 2, a non-limiting schematic illustration of the targeted message database 126 populated with the plurality of targeted messages 128 is illustrated.

The manner in which the targeted message database 126 is populated is not limited. Just as an example, the targeted message database 126 may receive the targeted messages from one or more advertisers. In some non-limiting embodiments of the present technology, the targeted messages stored within the targeted message database 126 are pay-per-view targeted messages. In some non-limiting embodiments of the present technology, the targeted messages stored within the targeted message database 126 may also include pay-per-click targeted messages.

In some non-limiting embodiments of the present technology, the targeted message database 126 includes additional information in respect to each of the plurality of targeted messages 128, such as targeting parameters. Example of targeting parameters may include a target visibility score (described in detail below), a minimum/maximum bidding price for each impression, a target audience, a content of the targeted message, indication of the targeted message being static or dynamic and the like.

For example, the targeted message database 126 may include a first targeted message 202 which may for example, be directed at a car advertisement, destined for males of ages 20 to 50. On the other hand, the targeted message database 126 may also include a second targeted message 204 which may for example, be an advertisement for a rent-a-car application with a target audience of people aged from 25 to 60 years old.

Referring back to FIG. 1, the server 118 is further coupled to a user profile database 127 via a dedicated link (not numbered). In alternative non-limiting embodiments of the present technology, the user profile database 127 may be communicatively coupled to the server 118 via the communication network 114 or be part of the server 118. Although the user profile database 127 is illustrated schematically herein as a single entity, it is contemplated that the user profile database 127 may be configured in a distributed manner.

Generally speaking, the user profile database 127 is a repository of one or more user profiles (not illustrated). How the one or more user profiles are implemented is not limited, and may for example be a set of vectors representing the interests of a given user.

How the user profile database 127 is populated with the one or more user profiles is not limited. Just as an example, the server 118 may be configured to analyze web navigation characteristics associated with the electronic devices (such as of the browser application 108 of the electronic device 102) to generate a user profile associated with the electronic device 102, as disclosed in a co-owned patent application entitled METHOD AND SYSTEM FOR DETERMINING AN OCCURRENCE OF A VISIT TO A VENUE BY A USER, bearing Attorney Docket number 40703-147 (a United States Patent Application number being not yet available); the content of which is hereby incorporated by reference in its entirety.

Additionally, there is provided a web server 130 coupled to the communication network 114. The web server 130 can (but does not have to) be implemented in a similar manner to the server 118. In the depicted embodiments of the present technology, the web server 130 is a single server. In alternative non-limiting embodiments of the present technology, the functionality of the web server 130 may be distributed and implemented via multiple servers.

In some non-limiting embodiments of the technology, the web server 130 functions as a repository for a plurality of web resources 132 (not individually numbered).

Generally speaking, the user of the electronic device 102 can access one of the web resources stored within the web server 130 via the communication network 114 by two principle means. The given user can access a particular web resource directly, either by typing an address of the web resource (typically an URL or Universal Resource Locator, such as www.example.com) into a command interface of the browser application 108 or by clicking a link in an e-mail or in another web resource (which action will in a sense “copy and paste” the URL associated with the link into the command interface).

Alternatively, the given user may conduct a search using the search engine application 134 stored within the server 118 to locate a resource of interest based on the user's search intent. The latter is particularly suitable in those circumstances, where the given user knows a topic of interest, but does not know the URL of the web resource she or he is interested in. The search engine application 134 typically returns a search engine result page (SERP) containing links to one or more web resources that are responsive to the user query. Again, upon the user clicking one or more links provided within the SERP the user can open the required web resource.

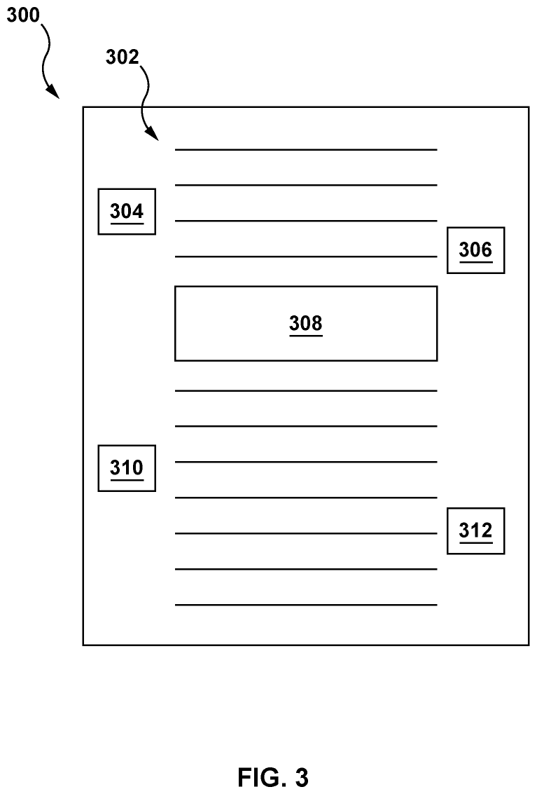

With reference to FIG. 3, there is depicted a non-limiting schematic illustration of a web resource 300 that is accessed by the browser application 108.

The web resource 300 comprises a body of text 302, and five (5) targeted message slots for accommodating a targeted message, namely a first slot 304, a second slot 306, a third slot 308, a fourth slot 310 and a fifth slot 312. For example, the first slot 304 and the fourth slot 310 are provided on the left side of the web resource 300, the second slot 306 and the fifth slot 312 are provided on the right side of the web resource 300, and finally the third slot 308 is provided within body of text 302. The web resource 300 may correspond to a SERP that is generated by the search engine application 134 or a web resource stored within the web server 130.

In some non-limiting embodiments of the present technology, the advertisement application 124 is configured to assign a given targeted message from the targeted message database 126 to each of the targeted message slot. In other words, when displayed on the electronic device 102, the web resource 300 can include a targeted message within some or all of the 5 targeted message slots. In some non-limiting embodiments of the present technology, the targeted messages may all be pay-per-view targeted messages, pay-per-click targeted messages, or a combination of both (ex. 3 pay-per-view targeted messages and 2 pay-per-click targeted messages).

How the advertisement application 124 selects a given targeted message and which slot within the web resource 300 the given targeted message is assigned to will now be explained.

Returning to FIG. 1, the advertisement application 124 is configured to execute a machine learning algorithm (MLA) 136. The MLA 136 is configured to predict a visibility score that is indicative of a likelihood of a targeted message included within a web resource (such as the web resource 300) being viewed by the user of the electronic device 102. Based on the predicted visibility score, the advertisement application 124 is configured to select the targeted message to be included within the web resource and the position of the targeted message within the web resource.

### MLA 136

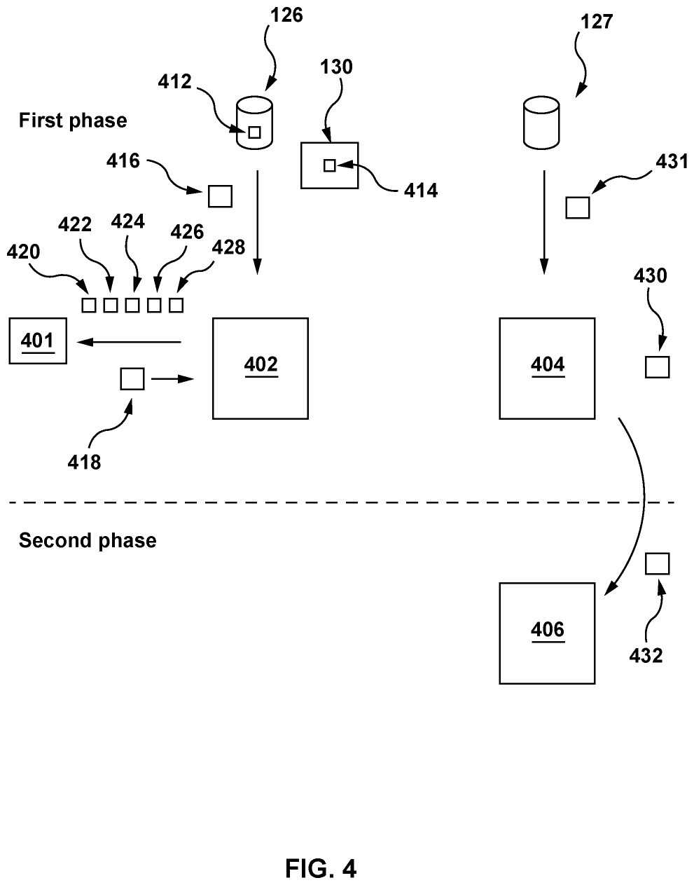

With reference to FIG. 4, a schematic process of training the MLA 136 is depicted.

For a better understanding of the underlying concepts of the present technology, it should be understood that the training of the MLA 136 can be broadly separated into a first phase and a second phase. In the first phase, the training input data (discussed below) is generated. In the second phase, the MLA 136 is trained using the training input data.

To train the MLA 136, the advertisement application 124 executes (or otherwise has access to): a generating routine 402, a tracking routine 404 and a training routine 406.

In the context of the present specification, the term “routine” refers to a subset of the computer executable program instructions of the advertisement application 124 that is executable by the server processor 122 to perform the functions explained below in association with the various routines (the generating routine 402, the tracking routine 404, and the training routine 406). For the avoidance of any doubt, it should be expressly understood that the generating routine 402, the tracking routine 404, and the training routine 406 are illustrated schematically herein as separate entities for ease of the processes executed by the advertisement application 124. It is contemplated that some or all of the generating routine 402, the tracking routine 404, and the training routine 406 may be implemented as one or more combined routines.

For ease of understanding the present technology, the functionality of each one of the generating routine 402, the tracking routine 404, and the training routine 406, as well as data and/or information processed or stored therein are described below.

The first phase of the training is executed by the generating routine 402, the tracking routine 404, and the second phase of the training is executed by the training routine 406.

### Generating Routine 402

How the training input data is generated will now be explained, which begins with the generating routine 402. As recalled, the targeted message database 126 includes the plurality of targeted messages 128 and the web server 130 stores the plurality of web resources 132. For the purpose of explaining the training phase, reference will be made to “training targeted message” and “training web resource” that are stored within the targeted message database 126 and the web server 130, respectively. It should be expressly understood that these training targeted message and training web resource need not be different from the targeted message and the web resource explained previously with reference to FIG. 1. In other words, the training targeted message and the training web resource may each be stored within the targeted message database 126 and the web server 130 respectively, using the same manner as described above.

For the purpose of illustration, it should be assumed that the targeted message database 126 includes a plurality of training targeted messages, which includes at least a training targeted message 412, and the web server 130 includes a training web resource 414 (which may correspond to the web resource 300, and as such will be referred to interchangeably).

A training electronic device 401 is configured to transmit a request to obtain the training web resource 414 via a data packet 418. How the request is made is not limited and may for example be by accessing the URL of the training web resource 414 (or alternatively, if the training web resource 414 is a SERP, by executing a search using the search engine application 134. As it will be made more apparent below, it should be understood that the training of the MLA 136 is executed while the user associated with the training electronic device 401 accesses real-life web sites. In other words, the training of the MLA 136 is executed while real-time users access websites.

In response to receiving the request for the training web resource 414, the generating routine 402 is configured to receive a data packet 416 which includes the plurality of training targeted messages and the training web resource 414. In some non-limiting embodiments of the present technology, the plurality of training targeted messages included within the data packet 416 are pay-per-click targeted messages.

In response to receiving the data packet 418, the generating routine 402 is configured to select one or more of the training targeted messages included in the plurality of training targeted messages to insert in one of the targeted message slot of the training web resource 414, prior to transmitting the training web resource 414 to the training electronic device 401.

For example, with reference to FIG. 3, the generating routine 402 is configured to select, for example, the training targeted message 412 to be inserted in one of the first slot 304, the second slot 306, the third slot 308, the fourth slot 310 and the fifth slot 312. How the generating routine 402 is configured to select the training targeted message 412 is not limited and may be done using conventional bidding processe(s), which would not be described herein.

In some non-limiting embodiments of the present technology, the training targeted message 412 may be inserted in more than one targeted message slot within the training web resource 414. For example, a given targeted message may be included in all of the targeted message slots, or fewer.

Referring back to FIG. 4, let us assume that in response to the data packet 418, the generating routine 402 inserts the training targeted message 412 into the first slot 304 of the training web resource 414 (i.e. the web resource 300). Needless to say, the generating routine 402 may insert the training targeted message 412 in a different slot of the training web resource 414.

After filling all of the slots (i.e. the first slot 304, the second slot 306, the third slot 308, the fourth slot 310 and the fifth slot 312) with a respective targeted message, the generating routine 402 is configured to transmit the training web resource 414 to the training electronic device 401 which sent the data packet 418 (such as the electronic device 102).

Although in the above example, only a single instance of the training web resource 414 with the training targeted message 412 has been explained, it is done so for ease of reference. It should be understood that the insertion of the training targeted message 412 into the training web resource 414 is done iteratively, at each request for the training web resource 414 by the training electronic device 401.

In some non-limiting embodiments of the present technology, for each instance that the training electronic device 401 requests the training web resource 414, the generating routine 402 is configured to insert the training targeted message 412 into the training web resource 414, but at different slots. For example, if at a first instance, the training targeted message 412 has been inserted into the first slot 304, the next instance when the training web resource 414 is requested, the training targeted message 412 will be inserted into a slot that is different from the first slot 304. In other words, the same training targeted message (i.e. the training targeted message 412) is inserted into the training web resource 414 on multiple occasions, over time, to be shown to the same user. In other words, for a given pair of the user and targeted message, the user gets exposed to the same targeted message at different placements.

Let us assume for example, that in total, the generating routine 402 has generated, over time, a total of five training web resources, namely a first training web resource 420, a second training web resource 422, a third training web resource 424, a fourth training web resource 426 and a fifth training web resource 428. Each of the first training web resource 420, the second training web resource 422, the third training web resource 424, the fourth training web resource 426 and the fifth training web resource 428 corresponds to the training web resource 414 but has the training targeted message 412 at a respective slot. For example, the first training web resource 420 may have the training targeted message 412 at the first slot 304, the second training web resource 422 may have the training targeted message 412 at the second slot 306 and so on.

It should be understood that each of the first training web resource 420, the second training web resource 422, the third training web resource 424, the fourth training web resource 426 and the fifth training web resource 428 are transmitted to the training electronic device 401 for display. More precisely, the first training web resource 420 is transmitted in response to a first request (i.e. the data packet 418) for the training web resource 414 by the electronic device 102, the second training web resource 422 is transmitted in response to a second (i.e. subsequent request to the first request) for the training web resource 414 by the electronic device 102 and so on.

### Tracking Routine 404

The tracking routine 404 is configured to track an activity parameter for each of the first training web resource 420, the second training web resource 422, the third training web resource 424, the fourth training web resource 426 and the fifth training web resource 428 after their sequential display on the training electronic device 401. In some non-limiting embodiment of the present technology, the activity parameter is indicative of an interaction by the user of the electronic device 102 with a given one of the training targeted message 412 included within each of the first training web resource 420, the second training web resource 422, the third training web resource 424, the fourth training web resource 426 and the fifth training web resource 428.

For example, taking the first training web resource 420 as an example, the activity parameter may be indicative of whether the user of the training electronic device 401 has (i) clicked on the training targeted message 412 and/or (ii) hovered on the training targeted message 412. In some non-limiting embodiments of the present technology, the activity parameter may be implemented as a binary parameter, where 1 represents a click/hover by the user on the training targeted message 412 and 0 represents no click/hover by the user on the training targeted message 412.

Just as an example, let us assume that the following Table 1 illustrates the training dataset that is generated by the generating routine 402.

TABLE 1

| | | Activity |
|---|---|---|
| Training web resource | Slot Location | Parameter |
| First training web resource 420 | 304 (Top Left) | 1 |
| Second training web resource 422 | 306 (Top Right) | 0 |
| Third training web resource 424 | 308 (Body) | 1 |
| Fourth training web resource 426 | 310 (Bottom Left) | 0 |
| Fifth training web resource 428 | 312 (Bottom Right) | 0 |

The Table 1 is indicative that the training targeted message 412 included within the first slot 304 (which is located on the top left side of the web resource 300) has been clicked/hovered by the user. On the other hand, the training targeted message 412 included within the second slot 306 (which is located on the top right side of the web resource 300) has been clicked/hovered by the user.

In some non-limiting embodiments of the present technology, the tracking routine 404 is further configured to retrieve a user profile 431 from the user profile database 127 that is associated with the user of the training electronic device 401. As alluded above, the user profile 431 is indicative of the interests associated with the user of the training electronic device 401.

In some non-limiting embodiments of the present technology, the tracking routine 404 is further configured to retrieve, from the training electronic device 401, device information that is associated with the training electronic device 401, such as the screen of the training electronic device 401 being one of a desktop, a smartphone, a tablet; the display size and the like.

In some non-limiting embodiments of the present technology, the tracking routine 404 is further configured to retrieve content information, such as a content topic, that is associated with the training web resource 414. For example, the content information may correspond to a topic of the training web resource 414. How the content topic of the training web resource 414 is determined is known in the art and will not be described in detail herein. An example of determining a topic of a web resource is disclosed in a co-owned United States Patent Publication No. 2017/0293683 A1 entitled METHOD AND SYSTEM FOR PROVIDING CONTEXTUAL INFORMATION, filed Mar. 21, 2017, the content of which is incorporated by reference herein in its entirety.

In some non-limiting embodiments of the present technology, the information contained within the Table 1, the user profile 431, the device information of the training electronic device 401, and the content information of the training web resource 414 form a training dataset 430, which is then transferred to the training routine 406 via a data packet 432. In some non-limiting embodiments of the present technology, it is contemplated that the information contained within the Table 1, together with one or more of the user profile 431, the device information of the training electronic device 401, and the content information of the training web resource 414 forms the training dataset 430.

### Training Routine 406

How the MLA 136 is trained using the training dataset 430 is now explained.

The training dataset 430 is inputted into the MLA 136. The MLA 136 includes a training logic to determine a set of features associated with the training dataset.

In some non-limiting embodiments of the present technology, the set of features include a position-activity feature, which is indicative of a relationship between the location of the training targeted message 412 within the training web resource 414 (i.e. web resource 300) and the corresponding activity parameter.

In some non-limiting embodiments of the present technology, the set of features include a preference-activity feature, which is indicative of a relation between the user profile 431, the location of the training targeted message 412 within the training web resource 414 and the corresponding activity parameter.

In some non-limiting embodiments of the present technology, the set of features includes a content-activity feature, which is indicative of a relation between the content information of the training web resource 414, the location of the training targeted message 412, and the corresponding activity parameter.

In some non-limiting embodiments of the present technology, the set of features includes a device-activity feature, which is indicative of a relation between the device information of the training electronic device 401, the location of the training targeted message 412 and the corresponding activity parameter.

Once the set of features within the training dataset 430 has been determined, the MLA 136 is configured to generate an inferred function which is configured to determine the visibility score of any given targeted message included within a web resource, based on the targeted message location of the targeted message. The visibility score is indicative of a likelihood of the targeted message included within the web resource being viewed by a user associated with an electronic device during the in-use phase (described in detail below).

Although the MLA 136 is configured to generate the inferred function based on the position-activity feature, the preference-activity feature, the content-activity feature and the device-activity feature, it is contemplated that the MLA 136 is configured to generate the inferred function based only on one or more of the position-activity feature, the preference-activity feature, the content-activity feature and the device-activity feature.

Needless to say, although there is only depicted a single instance of the training of the MLA 136, it is done so for ease of illustration. It should be expressly understood that the training of the MLA 136 is done iteratively using a plurality of training targeted messages and a plurality of training web resources.

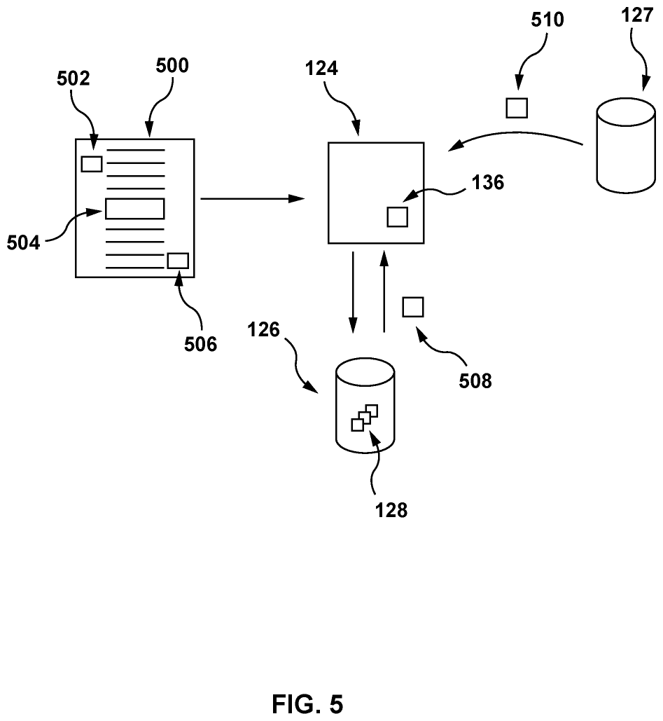

Turning now to FIG. 5, there is depicted a schematic diagram of a process of the in-use phase of the advertisement application 124.

At a first step, a web resource 500 is transmitted to the advertisement application 124. How the web resource 500 is transmitted to the advertisement application 124 is not limited, and suffice it to say that the web resource 500 has been requested by the electronic device 102. For example, the web resource 500 may correspond to a SERP that is generated by the search engine application 134 in response to a query inputted by the user of the electronic device 102. In another example, the web resource 500 may have been accessed by the electronic device 102 by accessing directly the URL of the web resource 500.

The web resource 500 comprises three targeted message slots, namely a first slot 502, a second slot 504 and a third slot 506.

In some non-limiting embodiments of the present technology, the advertisement application 124 is configured to retrieve, in response to receiving the web resource 500, one or more of: a user profile 510 that is associated with the electronic device 102 from the user profile database 127, the content information associated with the web resource 500, and the device information of the electronic device 102.

In response to receiving the web resource 500, the advertisement application 124 is configured to determine a visibility score for each of the first slot 502, the second slot 504 and the third slot 506.

More precisely, the advertisement application 124 executes the MLA 136 that is configured to predict the visibility score for each of the first slot 502, the second slot 504 and the third slot 506. In other words, the MLA 136 predicts a likelihood of a target message to be included in the first slot 502, the second slot 504 and the third slot 506 being viewed by the user of the electronic device 102, without the need of the user clicking on said targeted message(s).

As such a location of the first slot 502, the second slot 504 and the third slot 506 are inputted into the MLA 136. In some non-limiting embodiments of the present technology, one or more of the following information may be inputted into the MLA 136: (i) the user profile 510; (ii) the content information associated with the web resource 500; and (ii) the device information associated with the electronic device 102.

The MLA 136 is then configured to calculate a first visibility score associated with the first slot 502, a second visibility score associated with the second slot 504 and a third visibility score associated with the third slot 506.

As an example, let us assume that the following Table 2 illustrates the visibility score determined by the MLA 136 for the first slots 502, the second slot 504 and the third slot 506.

TABLE 2
Predicted visibility score of the targeted message 408

| Slot | Predicted Visibility Score |
|---|---|
| 502 | 60% |
| 504 | 70% |
| 506 | 30% |

As illustrated above, the MLA 136 has determined that the first visibility score (associated with the first slot 502) corresponds to 60%, the second visibility score (associated with the second slot 504) corresponds to 70%, and the third visibility score (associated with the third slot 506) corresponds to 30%.

In other words, the MLA 136 has determined that a given targeted message that is included within the second slot 504 has a highest chance of being viewed by the user.

Having determined the visibility score for each of the available slots (i.e. the first slot 502, the second slot 504 and the third slot 506), the advertisement application 124 is configured to execute an impression bid process. More precisely, the advertisement application 124 is configured to access the targeted message database 126 and determine which of the one or more of the targeted messages are to be included within the web resource 500 and which slot.

It should be understood from the above that the visibility score for each of the available slots (i.e. the first slot 502, the second slot 504 and the third slot 506) has been determined by the MLA 136 that has been trained using, inter alia, the activity parameter (which is indicative of an interaction by the user of the electronic device 102 with a given one of the training targeted message 412 included within each of the first training web resource 420, the second training web resource 422, the third training web resource 424, the fourth training web resource 426 and the fifth training web resource 428) as a proxy for the likelihood of the targeted message being viewed.

The idea of using the interaction by the user (i.e. the activity parameter) as a proxy for the likelihood of the targeted message being viewed is: p(click)=p(click|view)*p(view)+p(click|!view)*p(!view). Assuming that p(click|!view)=0, since one cannot click on a targeted message without seeing it, the formula results in p(click)=p(click|view)*p(view). Further assuming that p(click|view) only depends on the user's interested in the targeted message, the formula is shortened to p(click)=p(view).

Recalling that each targeted message stored within the targeted message database 126 is associated with a target visibility score, the impression bid comprises in selecting targeted messages that meet the predicted visibility score and selecting a highest bidding targeted message.

For example, let us assume that there are three targeted messages that are associated with a target visibility score of “at least 65%”, which meet the predicted visibility score of the second slot 504. The advertisement application 124 is then configured to select the targeted message that has a highest bidding value. In other words, it is contemplated that the price charged to the advertiser of the targeted message be dependent on the target visibility score.

Needless to say, although in the above example, only the highest bidding value is taken into account during the impression bidding process, it is not limited as such. It is contemplated that the impression bidding process takes into account additional target parameters of the targeted messages. For example, the impression bidding process may take into account the target audience and the content of the targeted message vis-a-vis the user profile 510 and the content of the web resource 500, such that the selected targeted message is related to the web resource 500 and/or the interest of the user of the electronic device 102.

Let us assume that following the impression bid process, the advertisement application 124 has selected a targeted message 508 for inclusion in the first slot 502. Needless to say, the impression bid process may also result in the advertisement application 124 selecting additional targeted message for inclusion in the second slot 504 and the third slot 506.

Once the web resource 500 has been populated with the targeted messages (i.e. a respective targeted message inserted in each of the first slot 502, the second slot 504 and the third slot 506), the advertisement application 124 transmits the web resource 500 to the electronic device 102 for display.

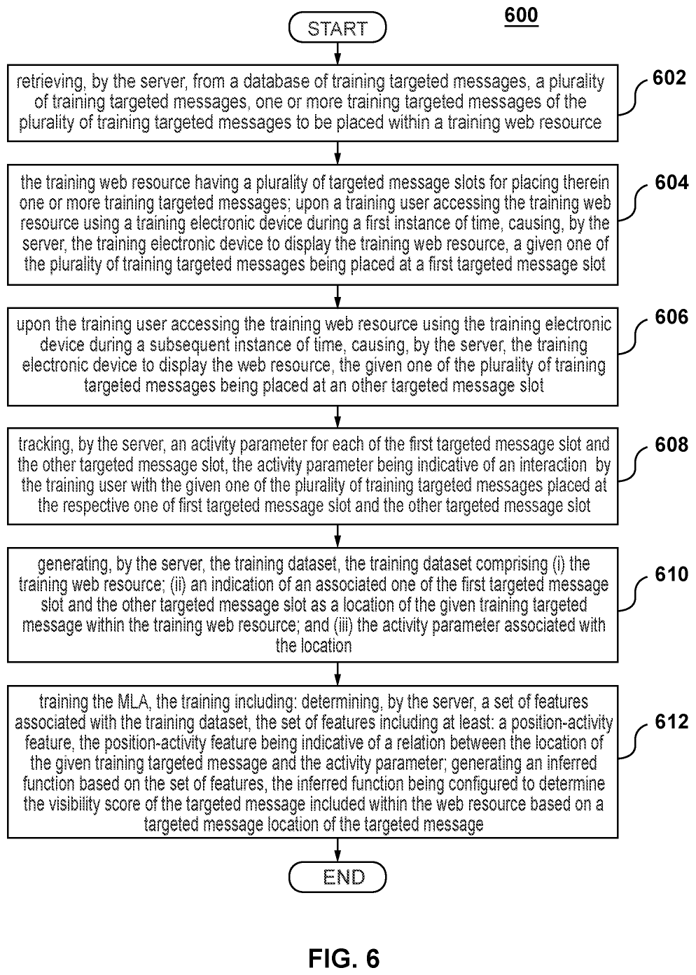

Given the architecture and examples provided hereinabove, it is possible to execute a computer-implemented method for training a MLA to predict a visibility score indicative of a likelihood of a targeted message included within a web resource being viewed by a user. With reference to FIG. 6, there is depicted a flow chart of a method 600 for training the MLA. The method 600 being executable in accordance with non-limiting embodiments of the present technology. The method 600 can be executed by the server 118.

Step 602: retrieving, by the server, from a database of training targeted messages, a plurality of training targeted messages, one or more training targeted messages of the plurality of training targeted messages to be placed within a training web resource

The method 600 starts at step 602, where the generating routine 402 receives the data packet 416 which includes the plurality of training targeted messages and the training web resource 414.

Step 604: the training web resource having a plurality of targeted message slots for placing therein one or more training targeted messages; upon a training user accessing the training web resource using a training electronic device during a first instance of time, causing, by the server, the training electronic device to display the training web resource, a given one of the plurality of training targeted messages being placed at a first targeted message slot

The training web resource 414 comprises the first slot 304, the second slot 306, the third slot 308, the fourth slot 310 and the fifth slot 312 for inserting the training targeted message 412.

In some non-limiting embodiments of the present technology, the training targeted message 412 may be inserted in more than one targeted message slot within the training web resource 414. For example, the targeted message slot may be included in all of the targeted message slot, or fewer.

The generating routine 402 inserts the training targeted message 412 into the first slot 304 of the training web resource 414 (i.e. the web resource 300).

The generating routine 402 is then configured to transmit the training web resource 414 (together with the training targeted message 412 inserted therein) to a training electronic device 401 which sent the data packet 418 (such as the electronic device 102).

Although in the above example, only a single instance of the training web resource 414 with the training targeted message 412 has been explained, it is done so for ease of reference. It should be understood that the insertion of the training targeted message 412 into the training web resource 414 is done iteratively, at each request for the training web resource 414 by the training electronic device 401.

In some non-limiting embodiments of the present technology, for each instance that the training electronic device 401 requests the training web resource 414, the generating routine 402 is configured to insert the training targeted message 412 into the training web resource 414, but at different slots. For example, if at a first instance, the training targeted message 412 has been inserted into the first slot 304, the next instance, the training targeted message 412 will be inserted into a slot that is different from the first slot 304.

Let us assume for example, that in total, the generating routine 402 has generated a total of five training web resources, namely a first training web resource 420, a second training web resource 422, a third training web resource 424, a fourth training web resource 426 and a fifth training web resource 428. Each of the first training web resource 420, the second training web resource 422, the third training web resource 424, the fourth training web resource 426 and the fifth training web resource 428 corresponds to the training web resource 414 but has the training targeted message 412 at a respective slot. For example, the first training web resource 420 may have the training targeted message 412 at the first slot 304, the second training web resource 422 may have the training targeted message 412 at the second slot 306 and so on.

Step 606: upon the training user accessing the training web resource using the training electronic device during a subsequent instance of time, causing, by the server, the training electronic device to display the web resource, the given one of the plurality of training targeted messages being placed at an other targeted message slot

At step 606, the first training web resource 420, the second training web resource 422, the third training web resource 424, the fourth training web resource 426 and the fifth training web resource 428 are transmitted to the training electronic device 401 for display. More precisely, the first training web resource 420 is transmitted in response to a first request for the training web resource 414 by the electronic device 102, the second training web resource 422 is transmitted in response to a second (i.e. subsequent request to the first request) for the training web resource 414 by the electronic device 102 and so on.

Step 608: tracking, by the server, an activity parameter for each of the first targeted message slot and the other targeted message slot, the activity parameter being indicative of an interaction by the training user with the given one of the plurality of training targeted messages placed at the respective one of first targeted message slot and the other targeted message slot

At step 606, At step 606, tracking routine 404 is configured to track an activity parameter for each of the first training web resource 420, the second training web resource 422, the third training web resource 424, the fourth training web resource 426 and the fifth training web resource 428. In some non-limiting embodiment of the present technology, the activity parameter is indicative of an interaction by the user of the electronic device 102 with a given one of the training targeted message 412 included within each of the first training web resource 420, the second training web resource 422, the third training web resource 424, the fourth training web resource 426 and the fifth training web resource 428

Step 610: generating, by the server, the training dataset, the training dataset comprising (i) the training web resource; (ii) an indication of an associated one of the first targeted message slot and the other targeted message slot as a location of the given training targeted message within the training web resource; and (iii) the activity parameter associated with the location

At step 610, the information contained within the Table 1, the user profile 431, the device information of the training electronic device 401, and the content information of the training web resource 414 form a training dataset 430, which is then transferred to the training routine 406 via a data packet 432. In some non-limiting embodiments of the present technology, it is contemplated that each of the information contained within the Table 1, the user profile 431, the device information of the training electronic device 401, and the content information of the training web resource 414 forms the training dataset 430.

Step 612: training the MLA, the training including: determining, by the server, a set of features associated with the training dataset, the set of features including at least: a position-activity feature, the position-activity feature being indicative of a relation between the location of the given training targeted message and the activity parameter; generating an inferred function based on the set of features, the inferred function being configured to determine the visibility score of the targeted message included within the web resource based on a targeted message location of the targeted message

At step 612, the training dataset 430 is inputted into the MLA 136. The MLA 136 includes a training logic to determine a set of features associated with the training dataset 430.

In some non-limiting embodiments of the present technology, the set of features include a position-activity feature, which is indicative of a relationship between the location of the training targeted message 412 within the training web resource 414 (i.e. web resource 300) and the corresponding activity parameter.

In some non-limiting embodiments of the present technology, the set of features include a preference-activity feature, which is indicative of a relation between the user profile 431, the location of the training targeted message 412 within the training web resource 414 and the corresponding activity parameter.

In some non-limiting embodiments of the present technology, the set of features includes a content-activity feature, which is indicative of a relation between the content information of the training web resource 414, the location of the training targeted message 412, and the corresponding activity parameter.

In some non-limiting embodiments of the present technology, the set of features includes a device-activity feature, which is indicative of a relation between the device information of the training electronic device 401, the location of the training targeted message 412 and the corresponding activity parameter.

Once the set of features within the training dataset 430 has been determined, the MLA 136 is configured to generate an inferred function which is configured to determine the visibility score of any given targeted message included within a web resource, based on the targeted message location of the targeted message. The visibility score is indicative of a likelihood of the targeted message included within the web resource being viewed by a user associated with an electronic device.

The method 600 then terminates.

It should be apparent to those skilled in the art that at least some embodiments of the present technology aim to expand a range of technical solutions for addressing a particular technical problem encountered by the conventional method of training a MLA.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

While the above-described implementations have been described and shown with reference to particular steps performed in a particular order, it will be understood that these steps may be combined, sub-divided, or reordered without departing from the teachings of the present technology. Accordingly, the order and grouping of the steps is not a limitation of the present technology.

1. A computer-implemented method for training a machine learning algorithm (MLA) to predict a visibility score indicative of a likelihood of a targeted message included within a web resource being viewed by a user, the user being associated with an electronic device configured to display the web resource, the method being executable on a server accessible by the electronic device via a communication network, the method comprising, at a training-phase:
generating a training dataset by:
retrieving, by the server, from a database of training targeted messages, a plurality of training targeted messages, one or more training targeted messages of the plurality of training targeted messages to be placed within a training web resource, the training web resource having a plurality of targeted message slots for placing therein one or more training targeted messages;
upon a training user accessing the training web resource using a training electronic device during a first instance of time, causing, by the server, the training electronic device to display the training web resource, a given one of the plurality of training targeted messages being placed at a first targeted message slot;
upon the training user accessing the training web resource using the training electronic device during a subsequent instance of time, causing, by the server, the training electronic device to display the web resource, the given one of the plurality of training targeted messages being placed at an other targeted message slot;
tracking, by the server, an activity parameter for each of the first targeted message slot and the other targeted message slot, the activity parameter being indicative of an interaction by the training user with the given one of the plurality of training targeted messages placed at the respective one of first targeted message slot and the other targeted message slot;
generating, by the server, the training dataset, the training dataset comprising (i) the training web resource; (ii) an indication of an associated one of the first targeted message slot and the other targeted message slot as a location of the given training targeted message within the training web resource; and (iii) the activity parameter associated with the location;
training the MLA, the training including:
determining, by the server, a set of features associated with the training dataset, the set of features including at least:
a position-activity feature, the position-activity feature being indicative of a relation between the location of the given training targeted message and the activity parameter;
generating an inferred function based on the set of features, the inferred function being configured to determine the visibility score of the targeted message included within the web resource based on a targeted message location of the targeted message.

2. The method of claim 1, wherein the visibility score is determined without the user clicking on the targeted message.

3. The method of claim 1, wherein the activity parameter is indicative of at least one of a click activity or a hover activity by the training user with the given one of the plurality of training targeted messages.

4. The method of claim 3, wherein the click activity parameter is a binary parameter.

5. The method of claim 3, wherein the training uses the activity parameter as a proxy for the likelihood of the targeted message being viewed.

6. The method of claim 4, wherein the use of the activity parameter as a proxy for the likelihood of the targeted message being viewed is based on a formula p(click)=p(click|view)*p(view)+p(click|!view)*p(!view).

7. The method of claim 1, wherein:
the training web resource is associated with a content topic; and
wherein the set of features further comprises:
a content-activity feature, the content activity feature being indicative of a relation between the location of the given training targeted message, the content topic and the activity parameter.

8. The method of claim 7, wherein the inferred function is configured to determine the visibility score of the targeted message included within the web resource based on the targeted message location and the content topic of the web resource.

9. The method of claim 1, wherein:
the training electronic device is associated with a device type; and
wherein the set of features further comprises:
a device-activity feature, the device-activity feature being indicative of a relation between the location of the given training targeted message, the activity parameter and the device type.

10. The method of claim 9, wherein the inferred function is configured to determine the visibility score of the targeted message included within the web resource based on the targeted message location and the device type of the electronic device.

11. The method of claim 1, wherein:
the training user is associated with a user profile, the user profile being indicative of web navigation characteristics associated with the training user.

12. The method of claim 11, wherein the training dataset further comprises the training user profile and the content topic, and wherein the set of features further comprises:
a preference-activity feature, the preference-activity feature being indicative of a relation between the training user profile, the location of the training targeted message, and the activity parameter.

13. The method of claim 12, wherein the inferred function is configured to determine the visibility score based on the user profile associated with the user and the targeted message location of the targeted message.

14. The method of claim 1, the method further comprising, during an in-use phase:
receiving, by the server, from the electronic device, a request for the web resource, the web resource having a plurality of potential locations for including the targeted message;
executing, by the server, an impression bid process prior to including the targeted message at the targeted message location of the web resource.

15. The method of claim 14, wherein executing the impression bid process comprises:
retrieving, by the server, from a targeted message database, the targeted message associated with a target visibility score;
generating, by the server, the visibility score for the targeted message for each potential location of the plurality of potential locations;
selecting, by the server, a given potential location associated with the visibility score that matches the target visibility score.

16. The method of claim 15, wherein the impression bid process is based on a pay-per-view model.

17. The method of claim 1, wherein the targeted message is a media ad.

18. A system for training a machine learning algorithm (MLA) to predict a visibility score indicative of a likelihood of a targeted message included within a web resource being viewed by a user, the user being associated with an electronic device configured to display the web resource, the system comprising a server accessible by the electronic device via a communication network, the server comprising a processor, the processor being configured to, at a training-phase:
generate a training dataset by:
retrieve, from a database of training targeted messages, a plurality of training targeted messages, one or more training targeted messages of the plurality of training targeted messages to be placed within a training web resource, the training web resource having a plurality of targeted message slots for placing therein one or more training targeted messages;
upon a training user accessing the training web resource using a training electronic device during a first instance of time, cause, by the server, the training electronic device to display the training web resource, a given one of the plurality of training targeted messages being placed at a first targeted message slot;
upon the training user accessing the training web resource using the training electronic device during a subsequent instance of time, cause the training electronic device to display the web resource, the given one of the plurality of training targeted messages being placed at an other targeted message slot;
track, an activity parameter for each of the first targeted message slot and the other targeted message slot, the activity parameter being indicative of an interaction by the training user with the given one of the plurality of training targeted messages placed at the respective one of first targeted message slot and the other targeted message slot;
generate, the training dataset, the training dataset comprising (i) the training web resource; (ii) an indication of an associated one of the first targeted message slot and the other targeted message slot as a location of the given training targeted message within the training web resource; and (iii) the activity parameter associated with the location;
train the MLA, the processor being configured to train the MLA by:
determine a set of features associated with the training dataset, the set of features including at least:
a position-activity feature, the position-activity feature being indicative of a relation between the location of the given training targeted message and the activity parameter;
generate an inferred function based on the set of features, the inferred function being configured to determine the visibility score of the targeted message included within the web resource based on a targeted message location of the targeted message.

19. The system of claim 18, wherein the activity parameter is indicative of at least one of a click activity or a hover activity by the training user with the given one of the plurality of training targeted messages.

20. The system of claim 19, wherein the training phase uses the activity parameter as a proxy for the likelihood of the targeted message being viewed.
